(19) United States
(12) Patent Application Publication
(10) Pub. No.: US 2017/0171501 A1
(43) Pub. Date: Jun. 15, 2017

(54) DEINTERLACING METHOD FOR INTERLACED VIDEO AND ELECTRONIC APPARATUS

(71) Applicants: Le Holdings (Beijing) Co., Ltd., Beijing (CN); LeCloud Computing Co., Ltd., Beijing (CN)

(72) Inventor: Maosheng Bai, Beijing (CN)

(21) Appl. No.: 15/247,660

(22) Filed: Aug. 25, 2016

Related U.S. Application Data
(63) Continuation of application No. PCT/CN2016/088690, filed on Jul. 5, 2016.

(30) Foreign Application Priority Data
Dec. 14, 2015 (CN) 201510927358.3

(51) Int. Cl. H04N 7/01

(52) U.S. Cl. CPC H04N 7/012

(57) ABSTRACT

The disclosure provides a deinterlacing method, a non-volatile computer storage medium and an electronic apparatus for an interlaced video. The deinterlacing method includes: Detecting a video to be processed being a field video. Determining video frames need to be performed the deinterlacing process in the field video. Performing the deinterlacing process to all pixels in each of the video frames need to be performed the deinterlacing process. Thus, the processing speed and the quality of the processed image are improved.

### CROSS-REFERENCE TO RELATED APPLICATIONS

This application is a continuation of International Application No. PCT/CN2016/088690, filed on Jul. 5, 2016, which is based upon and claims priority to Chinese Patent Application No. 201510927358.3, titled “DEINTERLACING METHOD FOR INTERLACED VIDEO AND ELECTRONIC APPARATUS”, filed on Dec. 14, 2015, the entire contents of which are incorporated herein by reference.

### TECHNICAL FIELD

The disclosure relates to technical field about video signal processing, and in particular relates to a deinterlacing method for an interlaced video, a non-volatile computer storage medium and an electronic apparatus.

### BACKGROUND

Phase Alternating Line (PAL) TV standard provides 25 frames per second. That is, the video which we usually watch is formed by replacement of 25 images per second. The human eye does not feel flicker because of the duration of vision. Each of the frames is divided into two fields to be scanned. Here the scanning refers to scan by the electron beam line by line and from top to bottom within the tube along a horizontal direction. The odd-numbered lines are scanned in the first field, and the even-numbered lines are scanned in the second field. That is called interlaced scan. A frame image is completed by scanning the two fields. The same frame image is scanned in the odd field and the even field when the field frequency is 50 Hz and the frame frequency is 25 Hz. The two adjacent frame images are different from each other, unless the images are stationary.

The field videos have already existed for many years to accommodate the interlaced scanning devices. With the development of science and technology, obvious field effect appears when the field videos are displayed in progressive scan devices (such as LCD display devices), that is, when the motion in the video is getting violent, the drawing in the video is correspondingly getting serious. Consequently, the user's watching experience of the video is seriously affected.

Thus, one deinterlacing method needs to be proposed.

### SUMMARY

A deinterlacing method for an interlaced video and an electronic apparatus are provided for solving the defect in conventional technology that an obvious field effect appears when the field videos are displayed in progressive scan devices, so as to realize the good image quality when playing video.

The embodiment of the disclosure provides a deinterlacing method for an interlaced video including the following steps:

detecting a video to be processed being a field video;

determining video frames need to be performed the deinterlacing process in the field video; and

performing the deinterlacing process to all pixels in each of the video frames need to be performed the deinterlacing process.

The embodiment of the disclosure provides a non-volatile computer storage medium, storing computer-executable instructions, the computer-executable instructions are configured for executing any one of the deinterlacing methods for an interlaced video mentioned above.

The embodiment of the disclosure provides an electronic apparatus, including at least one processor, and a memory for storing instructions executable by the at least one processor, wherein the instructions are executed by the at least one processor to perform any one of the deinterlacing methods for an interlaced video mentioned above.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a technical flow chart in an embodiment of the disclosure.

FIG. 2 is a schematic diagram of detection of field effect points of the disclosure.

FIG. 3 is a technical flow chart in another embodiment of the disclosure.

FIG. 4 is a schematic diagram of structure of the device in another embodiment of the disclosure.

FIG. 5 is a schematic diagram of hardware structure of the electronic apparatus for performing the deinterlacing method for an interlaced video in an embodiment of the disclosure.

### DETAILED DESCRIPTION

In order to present the purposes, technical solutions and advantages in the embodiments of the disclosure more clearly, the technical solutions in the embodiments of the disclosure as set forth below are described clearly and completely in conjunction with the accompanying drawings of the embodiments of the disclosure. It is obvious that the described embodiments are merely a part of the embodiments of the disclosure, but not all. Based on the embodiments of the disclosure, all other embodiments obtained by those of ordinary skill in the art without making creative efforts are also within the scope of the disclosure.

### Embodiment 1

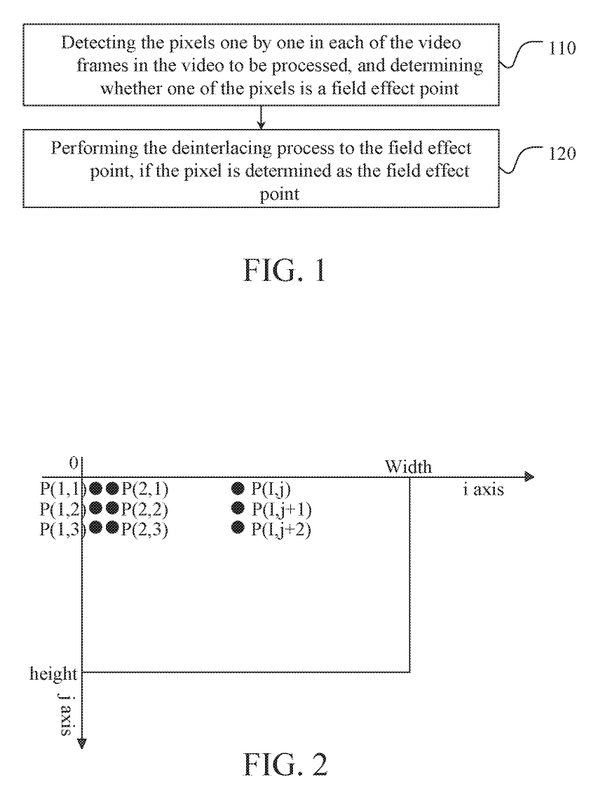

FIG. 1 is a technical flow chart in the embodiment 1 of the disclosure. In conjunction with FIG. 1, a deinterlacing method based on local information in the embodiment of the disclosure is implemented mainly by two major steps:

In the step 110: detect the pixels one by one in each of the video frames in the video to be processed, and determine whether one of the pixels is a field effect point.

Interlaced scan and progressive scan are both methods of presenting motion images in display devices. The way of interlaced scan is to divide each of the frames into two fields to display alternately. The way of progressive scan is to display all the pictures of each of the frames at the same time. The scan method applied in the displays of conventional LCD TVs is from left to right and from top to bottom, and the number of frames per second to scan is fixed.

Each of the frame images is generated by scanning by electron beam line by line sequentially and continuously. This kind of way to scan is called progressive scan. In order to obtain stable progressive scan images, each of the frame images should be scanned based on integer lines.

The way of interlaced scan is to divide each of the frames into two fields, and each of the fields includes all the odd-numbered scan lines or all the even-numbered scan lines of one frame. Usually, the first field is acquired by scanning the odd-numbered lines, and then the second field is acquired by scanning the even-numbered lines. Due to the duration of vision, the human eye will see the smooth movement rather than flash of the images of half frame and half frame. The line scan frequency of interlaced scan is half of that of progressive scan. Thus, spectrum of TV signal and channel bandwidth for transmitting the signal of interlaced scan is also half of that of progressive scan. After so using interlaced scan, in the case of small decline in image quality, the channel utilization becomes double. And the complexity and cost of the system and device are also reduced correspondingly, due to reduction of channel bandwidth.

However, when the field image is displayed by progressive scan device, field effect becomes very obvious.

Through a large number of experimental testing and analysis, it is discovered that, with respect to the field images, the deference of the pixel values between the adjacent lines is large, and the deference of the pixel values between interlaced lines is small. However, in a frame image, neither the deference of the pixel values between adjacent lines, nor the deference of the pixel values between interlaced lines are not large. Thus, the feature is able to be used for detection of field effect points.

Step 110 is further implemented by step 111˜step 112.

Step 111: acquire a first pixel difference value between the pixel and a pixel at the same position in an adjacent line, and a second pixel difference value between the pixel and a pixel at the same position in an interlaced line.

As shown in FIG. 2, in the video frame, pixel value p_{(i,j)} of i^{th} pixel of j^{th} line, pixel value p_{(i,j+1)} of i^{th} pixel of (j+1)^{th} line, and pixel value p_{(i,j+2)} of i^{th} pixel of (j+2)^{th} line are acquired, respectively.

A pixel difference value between the pixels at the same position in adjacent lines, and a pixel difference value between the pixels at the same position in interlaced lines are calculated, respectively. The calculating formula is shown as following.

Wherein, d1 is the first pixel difference value, d2 is the second pixel difference value.

Step 112: determine, according to a default similarity threshold value and a default difference threshold value, whether the pixel is the field effect point.

If the first pixel difference value and the second pixel difference value meet the following formula, determine the pixel as the field effect point:

d1>diff_{thd}&&d2<simi_thd

Wherein, simi_{—thd} is the similarity threshold value, simi_{—thd} is the difference threshold value, && indicates logic and operation.

The similarity threshold value and the difference threshold value are both empirical values. Usually, the default simi_{—thd}=10, simi_{—thd}=30.

It should be noted that, for a frame image, each of the pixels needs to be performed step 110. When one of the pixels is determined as the field effect point, the determined pixel, the corresponding front pixel and rear pixel (total 3 pixels) are all marked as field effect points.

In specific implementation of the step, the upper left corner point of the image is set as a coordinate origin of the video frame. The “width” and “height” mentioned later are width and height of a frame, respectively. For each of the frame images, an array mask[height] [width] is distributed to have the same size with the image. Each of the frames is set to 0 before processing. When p[y][x] is a field effect point, mask[y][x−1], mask[y][x] and mask[y][x+1] are set to 1.

Step 120: perform the deinterlacing process to the field effect point, if the pixel is determined as the field effect point.

The English of the word “deinterlacing” is deinterlacing. Simply put, deinterlacing is to convert an interlaced video to a progressive video. This is usually a process that amount of data becomes doubled and amount of information keeps constant.

After the detections of step 110 corresponding to each of the frames are completed, the array mask is acquired, which marks all field effect points of the corresponding frame. After traversing several array masks, when the corresponding value of array mask of the current pixel is 1 (it indicates that the current pixel is a field effect point), the deinterlacing process is performed to the current pixel. Otherwise, the processing of the current pixel is skipped.

In the embodiment of the disclosure, the applied deinterlacing algorithm is YADIF (Yet Another DeInterlacing Filter) algorithm. About the detail of deinterlacing algorithm, please refer to relevant technical information of conventional technique, here it is not repeated.

In the embodiment, the field effect points in the image is detected in advance, and the deinterlacing process is performed to the field effect points to convert a field video to a frame video, so as to achieve a low-cost and high-efficiency deinterlacing process, improve phenomenon of obvious field effect when displaying a field video in a progressive scan device, and improve the quality of the processed video.

### Embodiment 2

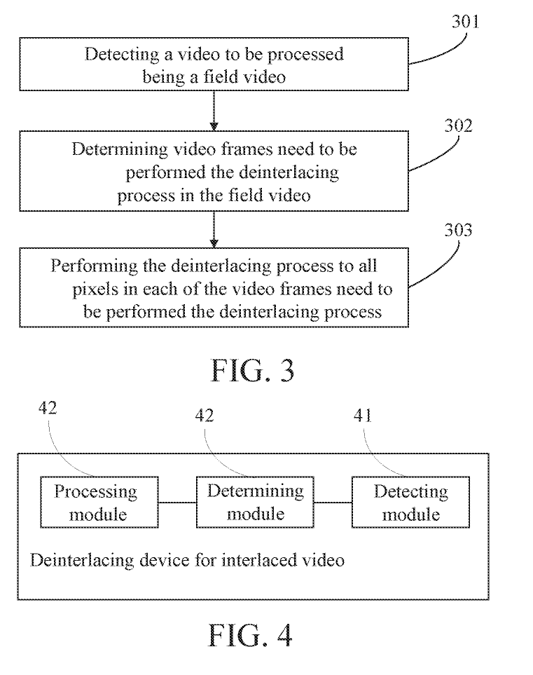

Based on a deinterlacing method based on local information based on embodiment shown in FIG. 1, FIG. 3 is a technical flow chart in the embodiment 2 of the disclosure. In conjunction with FIG. 3, a deinterlacing method for an interlaced video in the embodiment of the disclosure is implemented by the following steps specifically. The deinterlacing method includes:

In step 301, detect a video to be processed being a field video.

Based on the embodiment shown in FIG. 1, the step is implemented specifically to include:

Detect the pixels one by one in each of the video frames in the video to be processed, and determine whether one of the pixels is a field effect point.

Perform the deinterlacing process to the field effect point, if the pixel is determined as the field effect point.

determine, according to a number of the detected field effect points comprised in each of the video frames, the video frame as an obvious field image frame if the number of the field effect points is larger than a default obvious field threshold value.

determine, according to the number of the detected obvious field image frames, the video to be processed as the field video, if the number of the obvious field image frames is larger than a default video frame number threshold value.

In step 302, determine video frames need to be performed the deinterlacing process in the field video.

The step is implemented specifically, for example: determine, according to the number of the detected field effect points comprised in each of the video frames, the video frame as the video frames need to be performed the deinterlacing process, if the number of the field effect points is larger than a default single frame processing threshold value.

In step 303, perform the deinterlacing process to all pixels in each of the video frames need to be performed the deinterlacing process.

For example, perform the deinterlacing process to all the pixel in the video frames need to be performed the deinterlacing process based on YADIF algorithms.

By the following specific implementation, the technical solution of the disclosure is described in detail:

First, for each of the video frames, the detections of all the field effect points in the frame are performed. An array mask[height][width] is distributed to have the same size with the image. Each of the frames is set to 0 before processing. When p[y][x] is a field effect point, mask[y][x−1], mask[y][x] and mask[y][x+1] are all set to 1.

Then, according to array mask, the number of all the field effect points in each of the video frames is calculated and recorded as comb_cc. The number of obvious field image frames is set as comb_fn, an obvious field threshold value is set as abs_comb_thd, wherein abs_comb_thd=width*8. When the number of all the field effect points in each of the video frames comb_cc meets the formula 1, it indicates that the video frame is an obvious field image, and value of the number of obvious field image frames comb_fn is then incremented by 1.

comb_cc>abs_comb_thd formula 1

In order to improve processing speed and processing precision, determination of field video is performed first. That is, to determine whether the current video to be processed is a field video. When the current video to be processed is not a field video, the deinterlacing process is never performed, so as to save time and ensure quality.

When setting the detection period, the unit is the number of the frames: unit=fps*60*2, wherein, fps is frame rate of the video to be processed. Total frame number of the current video to be processed is set as total_fn. If the number of the detected obvious field image frames comb_fn meets formula 2, the current video to be processed is determined as a field video, and then performed the subsequent deinterlacing process. Otherwise, the current sequence is determined as the frame sequence, and the deinterlacing process is skipped.

comnb_fn>total_fn/unit formula 2

Further, if the current video to be processed is a field video, the deinterlacing process is performed to the current video frame by frame. The process is as follows. First, a single frame processing threshold value frame_comb_thd=272 is set to determine whether to perform a single frame process. Then, for each of the video frames, according to the number of all the field effect points detected above in each of the video frames comb_cc, whether to perform the deinterlacing process to the video frame is determined. If the number of all the field effect points in each of the video frames comb_cc meets formula 3, the video frame needs to perform the deinterlacing process is determined, and the deinterlacing process is performed to all the pixels of the video frame, wherein the deinterlacing process algorithm is YADIF (Yet Another Delnterlacing Filter) algorithm. Otherwise, the processing is skipped.

comb_cc>frame_comb_thd formula 3

In the disclosure, it is to perform the local deinterlacing first, to improve the processing speed. After that, a complete deinterlacing process is performed, so as to enhance the quality of treatment.

### Embodiment 3

FIG. 4 is a schematic diagram of structure of the device in the embodiment 3 of the disclosure. In conjunction with FIG. 4, a deinterlacing device based on interlaced video in the embodiment of the disclosure, mainly includes:

Detecting module 41 is configured for detecting a video to be processed being a field video.

Determining module 42 is configured for determining video frames need to be performed the deinterlacing process in the field video.

Processing module 43 is configured for performing the deinterlacing process to all pixels in each of the video frames need to be performed the deinterlacing process.

Wherein: the detecting module 41 is further configured for detecting the pixels one by one in each of the video frames in the video to be processed, and determining whether one of the pixels is a field effect point.

The processing module 43 is further configured for performing the deinterlacing process to the field effect point, if the pixel is determined as the field effect point.

The detecting module 41 is specifically configured for:

determining, according to a number of the detected field effect points comprised in each of the video frames, the video frame as an obvious field image frame if the number of the field effect points is larger than a default obvious field threshold value; and determining, according to the number of the detected obvious field image frames, the video to be processed as the field video, if the number of the obvious field image frames is larger than a default video frame number threshold value.

The determining module 42 is specifically configured for:

determining, according to the number of the detected field effect points comprised in each of the video frames, the video frame as the video frames need to be performed the deinterlacing process, if the number of the field effect points is larger than a default single frame processing threshold value.

The processing module 43 is configured for:

performing the deinterlacing process to all the pixel in the video frames need to be performed the deinterlacing process based on YADIF algorithms.

The device shown in FIG. 4 is able to execute the methods of embodiments shown in FIG. 1 or FIG. 3, the corresponding principle and technical effects will not repeat them.

### Embodiment 4

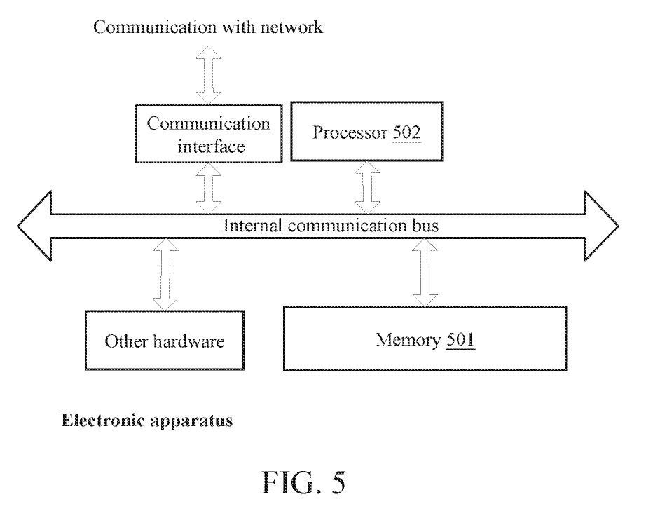

FIG. 5 is a schematic diagram of hardware structure of the electronic apparatus for performing the deinterlacing method for an interlaced video in the embodiment of the disclosure. The deinterlacing electronic apparatus includes:

one or more processor 502 and memory 501. FIG. 5 is an example of one processor 502.

The processor 502 and memory 501 can be connected to each other via a bus or other means. In FIG. 5, they are connected to each other via the bus in this embodiment.

The memory 501 is one kind of non-volatile computer-readable storage mediums applicable to store non-volatile software programs, non-volatile computer-executable programs and modules; for example, the program instructions and the function modules corresponding to the deinterlacing method for an interlaced video in the embodiments are respectively a computer-executable program and a computer-executable module. The processor 502 executes function applications and data processing of the server by running the non-volatile software programs, non-volatile computer-executable programs and modules stored in the memory 501, and thereby the deinterlacing method for an interlaced video in the aforementioned embodiments are achievable.

The memory 501 can include a program storage area and a data storage area, wherein the program storage area can store an operating system and at least one application program required for a function; the data storage area can store the data created according to the usage of the processing device for performing the deinterlacing method for an interlaced video. Furthermore, the memory 501 can include a high speed random-access memory, and further include a non-volatile memory such as at least one disk storage member, at least one flash memory member and other non-volatile solid state storage member. In some embodiments, the memory 501 can have a remote connection with the processor 502, and such memory can be connected to the processing device for performing the deinterlacing method for an interlaced video by a network. The aforementioned network includes, but not limited to, internet, intranet, local area network, mobile communication network and combination thereof.

The one or more modules are stored in the memory 501. When the one or more modules are executed by one or more processor 502, the deinterlacing method for an interlaced video is performed.

Those products above can perform the method provided in the embodiments of the disclosure which is performed in client, and these products have corresponding function modules to perform the method and provide corresponding advantageous effects. The technical details which are not mentioned in this embodiment can be found in the method provided in the above embodiments.

In conjunction with FIG. 5, a deinterlacing device based on interlaced video in the embodiment of the disclosure, mainly includes:

memory 501, processor 502, wherein,

The memory 501 is configured for storing one or more instructions, wherein the one or more instructions are executable by the processor.

The processor 502 is configured for detecting a video to be processed being a field video;

configured for determining video frames need to be performed the deinterlacing process in the field video; and

configured for performing the deinterlacing process to all pixels in each of the video frames need to be performed the deinterlacing process.

Wherein, the processor 502, is further configured for detecting the pixels one by one in each of the video frames in the video to be processed, and determining whether one of the pixels is the field effect point; and

configured for performing the deinterlacing process to the field effect point, if the pixel is determined as the field effect point.

The processor 502 is further configured for, determining, according to a number of the detected field effect points comprised in each of the video frames, the video frame as an obvious field image frame if the number of the field effect points is larger than a default obvious field threshold value; and

determining, according to the number of the detected obvious field image frames, the video to be processed as the field video, if the number of the obvious field image frames is larger than a default video frame number threshold value.

The processor 502 is further configured for, determining, according to the number of the detected field effect points comprised in each of the video frames, the video frame as the video frames need to be performed the deinterlacing process, if the number of the field effect points is larger than a default single frame processing threshold value.

The processor 502 is further configured for, performing the deinterlacing process to all the pixel in the video frames need to be performed the deinterlacing process based on YADIF algorithms.

The electronic apparatus in the embodiments of the present application is presence in many forms, and the electronic apparatus includes, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatus includes: audio, video player (e.g. iPod), handheld game console, e-books, as well as smart toys and portable vehicle-mounted navigation apparatus.

(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic apparatus having a data exchange function.

Technical solutions of the device and functional characteristics and connections of each of the modules, are corresponding to features and technical solutions described in the embodiments of FIGS. 1 to FIG. 5. For fully understanding, please refer to the aforementioned corresponding embodiments of FIGS. 1 to FIG. 5.

### Embodiment 5

The embodiment 5 of the disclosure provides a non-volatile computer storage medium, storing computer-executable instructions, the computer-executable instructions are configured for executing any one of the deinterlacing methods for an interlaced video in the embodiments mentioned above.

The devices in the embodiments described above are merely illustrative. Wherein the units or modules described above as separate members may or may not be physically separated. The member as the unit or module may be or may not be a physical unit or module. That is, the member as the unit or the module may be located in a place, or may be distributed in a plurality of network units. A part or all of the unit or module can be selected to achieve the purpose of the embodiments according to the actual needs. The person having ordinary skill in the art can understand and implement the embodiments without making creative effort.

Through the above described embodiments, those skilled in the art can clearly understand that various embodiments may be accomplished through software incorporated a necessary universal hardware platform to achieve. Of course, it may also be accomplished through hardware. Based on this understanding, the above technical solution or the part of the contribution to the prior art may be substantially embodied in the form of software products. The computer software product may be stored in a computer-readable storage medium, such as ROM/RAM, disk, CD-ROMs, etc, and may include a number of instructions for making a computer device (may be a personal computer, server, or network device) to perform the various embodiments or portions of the described embodiments of the mentioned method.

Finally, it should be noted that: In order to present the purposes, technical solutions and advantages in the embodiments of the disclosure more clearly, the technical solutions in the embodiments of the disclosure as set forth below are described clearly and completely in conjunction with the accompanying drawings of the embodiments of the disclosure. It is obvious that the described embodiments are merely a part of the embodiments of the disclosure, but not all. Based on the embodiments of the disclosure, all other embodiments obtained by those of ordinary skill in the art without making creative efforts are also within the scope of the disclosure.

What is claimed is:

1. A deinterlacing method for an interlaced video, applied in a terminal, wherein the deinterlacing method comprises:
detecting a video to be processed being a field video;
determining video frames need to be performed the deinterlacing process in the field video; and
performing the deinterlacing process to all pixels in each of the video frames need to be performed the deinterlacing process.

2. The deinterlacing method according to claim 1, wherein before detecting the video to be processed being the field video, the deinterlacing method comprises:
detecting the pixels one by one in each of the video frames in the video to be processed, and determining whether the pixel is a field effect point; and
performing the deinterlacing process to the field effect point, if the pixel is determined as the field effect point.

3. The deinterlacing method according to claim 1, wherein the detecting the video to be processed being the field video comprises:
determining, according to a number of the detected field effect points comprised in each of the video frames, the video frame as an obvious field image frame if the number of the field effect points is larger than a default obvious field threshold value; and
determining, according to the number of the detected obvious field image frames, the video to be processed as the field video, if the number of the obvious field image frames is larger than a default video frame number threshold value.

4. The deinterlacing method according to claim 1, wherein the determining video frames need to be performed the deinterlacing process in the field video, comprises:
determining, according to the number of the detected field effect points comprised in each of the video frames, the video frame as the video frames need to be performed the deinterlacing process, if the number of the field effect points is larger than a default single frame processing threshold value.

5. The deinterlacing method according to claim 1, wherein the performing the deinterlacing process to all the pixels in each of the video frames need to be performed the deinterlacing process, comprises:
performing the deinterlacing process to all the pixel in the video frames need to be performed the deinterlacing process based on YADIF algorithms.

6. The deinterlacing method according to claim 2, wherein the detecting the pixels one by one in each of the video frames in the video to be processed, and determining whether the pixel is the field effect point, comprises:
acquiring a first pixel difference value between the pixel and a pixel at the same position in an adjacent line, and a second pixel difference value between the pixel and a pixel at the same position in an interlaced line; and
determining, according to a default similarity threshold value and a default difference threshold value, whether the pixel is the field effect point.

7. The deinterlacing method according to claim 6, wherein the pixel is determined as the field effect point if the first pixel difference value and the second pixel difference value meet the following formula:
d1>diff_{thd}&&d2<simi_thd
wherein, d1 is the first pixel difference value, d2 is the second pixel difference value, simi_thd is the similarity threshold value, diff_thd is the difference threshold value, && indicates logic and operation, the similarity threshold value and the difference threshold value are empirical values.

8. A non-volatile computer storage medium, storing computer-executable instructions, wherein the computer-executable instructions are configured for:
detecting a video to be processed being a field video;
determining video frames need to be performed the deinterlacing process in the field video; and
performing the deinterlacing process to all pixels in each of the video frames need to be performed the deinterlacing process.

9. The non-volatile computer storage medium according to claim 8, wherein before detecting the video to be processed being the field video, comprises:
detecting the pixels one by one in each of the video frames in the video to be processed, and determining whether one of the pixels is a field effect point; and
performing the deinterlacing process to the field effect point, if the pixel is determined as the field effect point.

10. The non-volatile computer storage medium according to claim 8, wherein the detecting the video to be processed being the field video, comprises:
determining, according to a number of the detected field effect points comprised in each of the video frames, the video frame as an obvious field image frame if the number of the field effect points is larger than a default obvious field threshold value; and
determining, according to the number of the detected obvious field image frames, the video to be processed as the field video, if the number of the obvious field image frames is larger than a default video frame number threshold value.

11. The non-volatile computer storage medium according to claim 8, wherein the determining video frames need to be performed the deinterlacing process in the field video, comprises:
determining, according to the number of the detected field effect points comprised in each of the video frames, the video frame as the video frames need to be performed the deinterlacing process, if the number of the field effect points is larger than a default single frame processing threshold value.

12. The non-volatile computer storage medium according to claim 8, wherein the performing the deinterlacing process to all the pixels in each of the video frames need to be performed the deinterlacing process, comprises:
performing the deinterlacing process to all the pixel in the video frames need to be performed the deinterlacing process based on YADIF algorithms.

13. The non-volatile computer storage medium according to claim 9, wherein the detecting the pixels one by one in each of the video frames in the video to be processed, and determining whether one of the pixels is the field effect point, comprises:
acquiring a first pixel difference value between the pixel and a pixel at the same position in an adjacent line, and a second pixel difference value between the pixel and a pixel at the same position in an interlaced line; and
determining, according to a default similarity threshold value and a default difference threshold value, whether the pixel is the field effect point.

14. The non-volatile computer storage medium according to claim 13, wherein the pixel is determined as the field effect point if the first pixel difference value and the second pixel difference value meet the following formula:
d1>diff_{thd}&&d2<simi_thd
wherein, d1 is the first pixel difference value, d2 is the second pixel difference value, simi_thd is the similarity threshold value, diff_thd is the difference threshold value, && indicates logic and operation, the similarity threshold value and the difference threshold value are empirical values.

15. An electronic apparatus, comprising:
at least one processor; and
a memory communicably connected with the at least one processor, wherein the memory stores instructions executable by the at least one processor, and execution of the instructions by the at least one processor causes the at least one processor to:
detecting a video to be processed being a field video;
determining video frames need to be performed the deinterlacing process in the field video; and
performing the deinterlacing process to all pixels in each of the video frames need to be performed the deinterlacing process.

16. The electronic apparatus according to claim 15, wherein before detecting the video to be processed being the field video, comprises:
detecting the pixels one by one in each of the video frames in the video to be processed, and determining whether one of the pixels is a field effect point; and
performing the deinterlacing process to the field effect point, if the pixel is determined as the field effect point.

17. The electronic apparatus according to claim 15, wherein the detecting the video to be processed being the field video, comprises:
determining, according to a number of the detected field effect points comprised in each of the video frames, the video frame as an obvious field image frame if the number of the field effect points is larger than a default obvious field threshold value; and
determining, according to the number of the detected obvious field image frames, the video to be processed as the field video, if the number of the obvious field image frames is larger than a default video frame number threshold value.

18. The electronic apparatus according to claim 15, wherein the determining video frames need to be performed the deinterlacing process in the field video, comprises:
determining, according to the number of the detected field effect points comprised in each of the video frames, the video frame as the video frames need to be performed the deinterlacing process, if the number of the field effect points is larger than a default single frame processing threshold value.

19. The electronic apparatus according to claim 15, wherein the performing the deinterlacing process to all the pixels in each of the video frames need to be performed the deinterlacing process, comprises:
performing the deinterlacing process to all the pixel in the video frames need to be performed the deinterlacing process based on YADIF algorithms.

20. The electronic apparatus according to claim 16, wherein the detecting the pixels one by one in each of the video frames in the video to be processed, and determining whether one of the pixels is the field effect point, comprises:
acquiring a first pixel difference value between the pixel and a pixel at the same position in an adjacent line, and a second pixel difference value between the pixel and a pixel at the same position in an interlaced line; and
determining, according to a default similarity threshold value and a default difference threshold value, whether the pixel is the field effect point.
d1>diff_{thd}&&d2<simi_{thd} d1>diff_{thd}&&d2<simi_{thd}
